(19) United States
(12) Patent Application Publication
(10) Pub. No.: US 2026/0296290 A1
(43) Pub. Date: Oct. 1, 2026

(54) VEHICLE CONTROL SYSTEM AND METHOD PROVIDING HEIGHT ADJUSTMENT FUNCTION OF REAR SEAT FOOTREST

(71) Applicant: HYUNDAI MOBIS CO., LTD., Seoul (KR)

(72) Inventor: Yong Bum Park, Yongin-si (KR)

(73) Assignee: HYUNDAI MOBIS CO., LTD., Seoul (KR)

(21) Appl. No.: 19/570,862

(22) Filed: Mar. 18, 2026

(30) Foreign Application Priority Data
Mar. 31, 2025 (KR) 10-2025-0041384

(51) Int. Cl. B60N 3/06

(52) U.S. Cl. CPC B60N 3/063

(57) ABSTRACT

A vehicle control system for providing a height adjustment function of a rear seat footrest includes: an opening/closing sensor configured to sense whether a rear door is opened or closed, a seating sensor configured to sense whether a rear seat is occupied, a seat sensor configured to sense a position and angle of a front seat located in front of the rear seat, a user input assembly configured to receive an input from an occupant, a controller connected to the opening/closing sensor, the seating sensor, the seat sensor, and the user input unit, the controller being configured to generate and transmit a control signal, and a driver configured to drive the rear seat footrest based on the control signal. The vehicle control system may provide a height adjustment function for the rear footrest for the comfort of occupants seated in the rear seats of the vehicle.

Pursuant to 35 U.S.C. § 119(a), this application claims the benefit of earlier filing dates and right of priority to Korean Application No., filed on, the contents of which are hereby incorporated by reference herein in their entirety.

### BACKGROUND OF THE DISCLOSURE

### Field of the Disclosure

The present disclosure relates to a vehicle control system and method that provide a height-adjusting function of a rear seat footrest for the convenience of occupants seated in rear seats of a vehicle.

### Discussion of the Related Art

Typically, vehicles are equipped with seats designed to help occupants maintain a comfortable posture. These seats are generally manufactured based on the body size of an average adult, following standardized dimensions and shapes.

In the case of front seats, such as the driver's seat and the front occupant seat, guide rails are installed under the seats, allowing users to slidably move the seats forward and backward. Additionally, the backrest angle of the front seats may be adjusted by a user.

When a parent drives a vehicle accompanied by a child, the parent typically sits in the driver's seat and the front occupant seat, while the child usually sits in a rear seat. However, the child may feel discomfort because their feet may not reach the floor. This is because, as described above, the seats in the vehicle are provided in standardized dimensions and shapes without taking the occupant's body size into consideration.

As family vehicles grow increasingly popular, a need arises for a system that provides a height adjustment function of rear seat footrests to enhance comfort for occupants seated in the rear. Furthermore, there is a growing demand for solutions that go beyond manual adjustment, specifically, systems that utilize vehicle functions to automate and motorize the adjustment of the height of the rear seat footrest.

### SUMMARY OF THE DISCLOSURE

An object of the present disclosure is to provide a vehicle control system and method that provide a height adjustment function of the rear seat footrest to enhance the comfort of occupants sitting in the rear seats.

Another object of the present disclosure is to provide a vehicle control system and method capable of storing input information received from an occupant, allowing the rear seat footrest height to be automatically adjusted.

Another object of the present disclosure is to provide a vehicle control system and method capable of providing the height adjustment function of the rear seat footrest without interfering with the front seats.

The objects to be achieved by the present disclosure are not limited to those mentioned above, and other technical objects not explicitly stated will become readily apparent to those skilled in the art from the detailed description provided below.

To achieve these objects and other advantages and in accordance with the purpose of the disclosure, as embodied and broadly described herein, a vehicle control system for providing a height adjustment function of a rear seat footrest may include an opening/closing sensor configured to sense whether a rear door is opened or closed, a seating sensor configured to sense whether a rear seat is occupied, a seat sensor configured to sense a position and angle of a front seat located in front of the rear seat, a user input unit configured to receive an input from an occupant, a controller connected to the opening/closing sensor, the seating sensor, the seat sensor, and the user input unit, the controller being configured to generate and transmit a control signal, and a driver configured to drive the rear seat footrest based on the control signal to provide the height adjustment function.

Based on that the rear door is opened or closed and the occupant is seated on the rear seat, the controller may output information for driving the rear seat footrest through the user input unit, and generate the control signal based on input information received from the occupant.

Based on interference with the sensed front seat occurring during the driving of the rear seat footrest, the controller may output, through the user input unit, information indicating that the driving of the rear seat footrest is obstructed.

Based on interference with the sensed front seat occurring during the driving of the rear seat footrest, the controller may generate a control signal for adjusting an angle of the rear seat footrest. The driver may adjust the angle of the rear seat footrest based on the control signal to provide the height adjustment function.

The vehicle control system may further include a storage unit configured to store the input information received from the occupant.

Based on that the rear door is opened or closed and the rear seat is not sensed to be occupied, the controller may generate a control signal to return the rear seat footrest to an original position of the rear seat footrest.

Based on that an engine of the vehicle is turned off or that doors of the vehicle are in a locked state, the driver may return the rear seat footrest to the original position to provide the height adjustment function.

The driver may include a first driver disposed at a front lower portion of the rear seat footrest, and a second driver disposed at a rear lower portion of the rear seat footrest.

In another aspect of the present disclosure, a vehicle control method for providing a height adjustment function of a rear seat footrest may include sensing whether a rear door is opened or closed through an opening/closing sensor, sensing whether a rear seat is occupied through a seating sensor, outputting information for driving the rear seat footrest through a user input unit, generating a control signal based on input information received from an occupant, and driving the rear seat footrest through a driver based on the control signal to provide the height adjustment function.

The vehicle control method may further include sensing a position and angle of a front seat located in front of the rear seat through a seat sensor, and, based on interference with the sensed front seat occurring during the driving of the rear seat footrest, outputting, through the user input unit, information indicating that the driving of the rear seat footrest is obstructed.

According to the present disclosure, a vehicle control system and method may provide a height adjustment function of the rear seat footrest to enhance the comfort of occupants seated in the rear seats.

Additionally, by storing input information received from occupants, the height adjustment function of the rear seat footrest may be automatically provided.

Further, the height adjustment function of the rear seat footrest may be provided without causing interference with the front seats.

The effects obtainable from the present disclosure are not limited to those mentioned above, and other effects not mentioned above will be readily understood by those skilled in the art based on the following detailed description.

### BRIEF DESCRIPTION OF THE DRAWINGS

FIG. 1 is a block diagram of a vehicle system according to embodiments;

FIG. 2 is an example diagram illustrating the structure of a vehicle according to embodiments;

FIG. 3 is a block diagram of a vehicle control system according to embodiments;

FIG. 4 is a diagram illustrating how the vehicle control system provides a height adjustment function of a rear seat footrest according to embodiments;

FIG. 5 is a diagram illustrating the height adjustment function provided by the vehicle control system by adjusting an angle of the rear seat footrest according to embodiments;

FIG. 6 is a diagram illustrating a vehicle control method according to embodiments;

FIG. 7 is a diagram illustrating a case where interference occurs with a front seat in the vehicle control method according to embodiments; and

FIG. 8 is a diagram illustrating a case where a rear seat footrest returns to the original position thereof in the vehicle control method according to embodiments.

### DETAILED DESCRIPTION OF THE DISCLOSURE

Hereinafter, embodiments disclosed herein will be described in detail with reference to the accompanying drawings. Wherever possible, the same reference numbers will be used throughout the drawings to refer to the same or like parts, and redundant descriptions thereof will be omitted. The suffixes “module” and “unit” of elements herein are used for convenience of description and thus are used interchangeably and do not have any distinguishable meanings or functions. Further, in describing the embodiments disclosed in this specification, if a detailed description of related known techniques would unnecessarily obscure the gist of the embodiments disclosed in this specification, detailed description thereof will be omitted. In addition, the attached drawings are provided for easy understanding of the embodiments disclosed in this specification and do not limit technical idea disclosed in this specification, and the embodiments should be construed as including all modifications, equivalents, and alternatives falling within the spirit and scope of the present disclosure.

Terms containing ordinal numbers, such as first and second may be used to describe various components, but the components are not limited by such terms. These terms are used only to distinguish one component from another.

When a component is described as being “connected” or “linked” to another component, it should be understood that it may be directly connected or linked to the other component, but there may be other components in between. On the other hand, when a component is described as being “directly connected” or “linked” to another component, it should be understood that there is no other component in between.

As used herein, the singular forms “a”, “an”, and “the” include plural referents unless context clearly dictates otherwise.

In this specification, terms such as “includes” or “has” are intended to specify the presence of the features, numbers, steps, operations, components, parts, or combinations thereof disclosed in the specification, and are not to be understood as precluding the possibility of the presence or addition of one or more other features, numbers, steps, operations, components, parts, or combinations thereof.

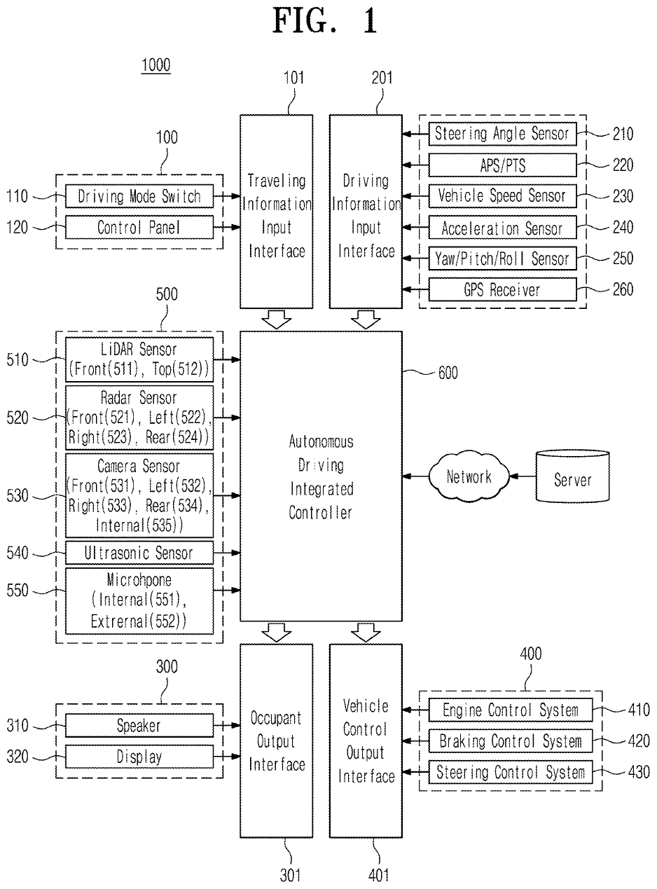

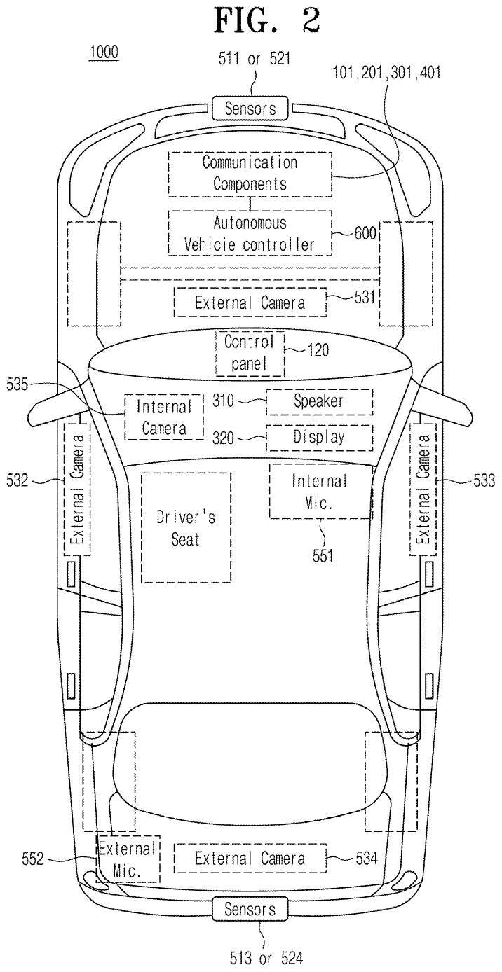

FIG. 1 is a block diagram of a vehicle system according to embodiments. FIG. 2 is an example diagram illustrating the structure of a vehicle according to embodiments.

FIG. 2 illustrates a vehicle to which the vehicle system of FIG. 1 is applied.

The vehicle according to embodiments may be configured as shown in FIG. 2 and may perform autonomous driving using an autonomous driving control system. The vehicle according to the embodiments may be referred to as an autonomous vehicle, robot, UAM (Urban Air Mobility), or autonomous driving apparatus.

The autonomous vehicle 1000 may be implemented centering on an autonomous driving integrated controller 600 that transmits and receives data necessary for autonomous driving control of the autonomous vehicle via a travel information input interface 101, a driving information input interface 201, an occupant output interface 301, and autonomous vehicle control output interface 401. The autonomous driving integrated controller 600 may also be referred to in the present disclosure as a processor or simply as a controller.

The autonomous driving integrated controller 600 may acquire travel information according to operations by an occupant on a user input unit 100 in the autonomous driving mode or the manual driving mode via the travel information input interface 101. As shown in FIG. 1, the user input unit 100 may include a driving mode switch 110 and a control panel 120 (e.g., a navigation device mounted in the autonomous vehicle, a smartphone or tablet PC held by the occupant, etc.). In some embodiments, the user input unit 100 may be referred to as a user input device, a user interface, or a user input assembly. Accordingly, the travel information may include driving mode information and navigation information related to the autonomous vehicle.

For example, the driving mode of the autonomous vehicle (i.e., autonomous/manual driving mode or sports mode/eco mode/safe mode/normal mode) determined by the occupant's operation of the driving mode switch 110 may be transmitted to the autonomous driving integrated controller 600 via the travel information input interface 101 as part of the driving information.

In addition, navigation information such as the occupant's destination and the route to the destination (e.g., the shortest or preferred route selected by the occupant among candidate routes) input through the control panel 120 may be transmitted to the autonomous driving integrated controller 600 as part of the travel information via the travel information input interface 101.

The control panel 120 may be implemented as a touch screen panel that provides a user interface (UI) for the occupant to input or modify information for autonomous driving control of the autonomous vehicle. In this case, the driving mode switch 110 may be implemented as a touch button on the control panel 120.

Furthermore, the autonomous driving integrated controller 600 may acquire driving information indicating the driving state of the autonomous vehicle via the driving information input interface 201. The driving information may include various kinds of information indicating the driving states and behaviors of the autonomous vehicle, such as a steering angle formed by manipulation of the steering wheel by an occupant, an accelerator pedal stroke or brake pedal stroke generated by pressing the accelerator pedal or the brake pedal, and behaviors of the autonomous vehicle such as vehicle speed, acceleration, yaw, pitch, and roll. As shown in FIG. 1, these pieces of driving information may be detected by a driving controller 200 including a steering angle sensor 210, an APS (Accel Position Sensor)/PTS (Pedal Driving Sensor) 220, a vehicle speed sensor 230, an acceleration sensor 240, and a yaw/pitch/roll sensor 250.

In addition, the driving information related to the autonomous vehicle may include location information. The location information may be obtained via a global positioning system (GPS) receiver 260 applied to the autonomous vehicle. The driving information may be transmitted to the autonomous driving integrated controller 600 via the driving information input interface 201 and used to control driving of the autonomous vehicle in the autonomous or manual driving mode.

The autonomous driving integrated controller 600 may also transmit driving state information provided to the occupant in the autonomous or manual driving mode to an output unit 300 via the occupant output interface 301. That is, by transmitting driving state information related to the autonomous vehicle to the output unit 300, the autonomous driving integrated controller 600 may allow the occupant to confirm the autonomous or manual driving state of the autonomous vehicle based on the driving state information output through the output unit 300. The driving state information may include various kinds of information indicating the driving state of the autonomous vehicle, such as, for example, the current driving mode of the autonomous vehicle, a transmission gear range, and a vehicle speed.

Additionally, when it is determined that a warning needs to be provided to the occupant in the autonomous or manual driving mode, the autonomous driving integrated controller 600 may transmit warning information to the output unit 300 via the occupant output interface 301 in addition to the driving state information, allowing the output unit 300 to provide a warning to the occupant. To output the driving state and warning information both audibly and visually, the output unit 300 may include a speaker 310 and a display 320, as shown in FIG. 1. The display 320 may be implemented as the same device as the control panel 120, or may be implemented as a separate independent device.

In addition, the autonomous driving integrated controller 600 may transmit control information for control of driving of the autonomous vehicle in the autonomous driving mode or manual driving mode to a lower-level control system 400 applied to the autonomous vehicle via the autonomous vehicle control output interface 401. As illustrated in FIG. 1, the lower-level control system 400 for control of driving of the autonomous vehicle may include an engine control system 410, a braking control system 420, and a steering control system 430. The autonomous driving integrated controller 600 may transmit engine control information, braking control information, and steering control information as the control information to each of the lower-level control systems 410, 420, 430 via the autonomous vehicle control output interface 401. Accordingly, the engine control system 410 may control the speed and acceleration of the autonomous vehicle by increasing or decreasing the fuel supplied to the engine. The braking control system 420 may control the braking of the autonomous vehicle by adjusting the braking force of the autonomous vehicle. The steering control system 430 may control the steering of the autonomous vehicle through a steering device (e.g., a Motor Driven Power Steering (MDPS) system) applied to the vehicle.

As described above, the autonomous driving integrated controller 600 of the present embodiment may acquire travel information based on occupant operation via the travel information input interface 101 and driving information indicating the driving state of the autonomous vehicle via the driving information input interface 201. It may transmit driving state information and warning information generated according to an autonomous driving algorithm to the output unit 300 via the occupant output interface 301. Furthermore, it may transmit control information generated according to the autonomous driving algorithm to the lower-level control system 400 via the autonomous vehicle control output interface 401 such that driving control of the autonomous vehicle may be carried out.

To ensure stable autonomous driving of the autonomous vehicle, it is necessary to accurately measure the driving environment of the autonomous vehicle to continuously monitor the driving state and control driving according to the measured driving environment. To this end, the autonomous driving apparatus of the present embodiment may include a sensing module 500 configured to detect objects around the autonomous vehicle, such as nearby autonomous vehicles, pedestrians, roads, or fixed facilities (e.g., traffic lights, signposts, traffic signs, construction fences, etc.), as illustrated in FIG. 1.

As shown in FIG. 1, the sensing module 500 may include one or more of a LiDAR sensor 510, radar sensor 520, and camera sensor 530 to detect nearby objects outside the autonomous vehicle.

The LiDAR sensor 510 may transmit laser signals around the autonomous vehicle and receive signals reflected from objects to detect nearby objects outside the autonomous vehicle. Depending on its specifications, it may detect nearby objects located within a predefined detection range, vertical field of view, and horizontal field of view. The LiDAR sensor 510 may include a front LiDAR sensor 511, a top LiDAR sensor 512, and a rear LiDAR sensor 513, installed at the front, top, and rear of the autonomous vehicle, respectively. The installation locations and numbers thereof are not limited to a specific embodiment. A threshold value used to determine the validity of a reflected laser signal may be pre-stored in a memory not shown of the autonomous driving integrated controller 600. The autonomous driving integrated controller 600 may determine the location (including the distance to the object), speed, and direction of movement of the object by measuring the time it takes for the laser signal to return after being reflected.

The radar sensor 520 emits electromagnetic waves around the autonomous vehicle and receives signals reflected from objects to detect nearby objects outside the autonomous vehicle. Depending on its specifications, it may detect nearby objects located within a predefined detection range, vertical field of view, and horizontal field of view. The radar sensor 520 may include a front radar sensor 521, a left radar sensor 522, a right radar sensor 523, and a rear radar sensor 524, installed at the front, left, right, and rear of the vehicle, respectively. The installation locations and numbers thereof are not limited to a specific embodiment. The autonomous driving integrated controller 600 may determine the location (including the distance to the object), speed, and direction of movement of the object by analyzing the power of the electromagnetic waves transmitted and received through the radar sensor 520.

The camera sensor 530 captures images of the surroundings of the autonomous vehicle to detect nearby objects outside the autonomous vehicle. Depending on its specifications, it may detect nearby objects located within a predefined detection range, vertical field of view, and horizontal field of view.

The camera sensor 530 may include a front camera sensor 531, a left camera sensor 532, a right camera sensor 533, and a rear camera sensor 534, installed at the front, left, right, and rear of the vehicle, respectively. The installation locations and numbers thereof are not limited to a specific embodiment. The autonomous driving integrated controller 600 may determine the location (including the distance to the object), speed, and direction of movement of the object by applying a predefined image processing method to images captured by the camera sensor 530.

Additionally, an internal camera sensor 535 configured to take an image of the interior of the autonomous vehicle may be mounted at a predetermined position (e.g., rearview mirror) inside the autonomous vehicle. The autonomous driving integrated controller 600 may monitor the occupant's behavior and condition based on the images captured by the internal camera sensor 535 and provide guidance or warnings to the occupant through the output unit 300 described above.

In addition to the LiDAR sensor 510, radar sensor 520, and camera sensor 530, the sensing module 500 may further include an ultrasonic sensor 540, as illustrated in FIG. 1. Various other types of sensors may also be adopted in the sensing module 500 to detect nearby objects around the autonomous vehicle.

FIG. 2 illustrates an example configuration in which a front LiDAR sensor 511 or front radar sensor 521 is installed at the front of the autonomous vehicle, a rear LiDAR sensor 513 or rear radar sensor 524 is installed at the rear, and a front camera sensor 531, a left camera sensor 532, a right camera sensor 533, and a rear camera sensor 534 are installed on the front, left, right, and rear sides. However, as mentioned above, the installation locations and numbers of each sensor are not limited to a specific embodiment.

To determine the condition of occupants in the autonomous vehicle, the sensing module 500 may further include a biometric sensor configured to detect biometric signals (e.g., heart rate, electrocardiogram (ECG), respiration, blood pressure, body temperature, brain waves, blood flow (pulse wave), and blood sugar). The biometric sensors may include a heart rate sensor, an ECG sensor, a respiration sensor, a blood pressure sensor, a body temperature sensor, an electroencephalogram sensor, a photoplethysmography sensor, and a blood glucose sensor.

Finally, the sensing module 500 may further include a microphone 550 including an internal microphone 551 and an external microphone 552, which are used for different purposes.

The internal microphone 551 may, for example, be used to analyze the voice of an occupant in the autonomous vehicle 1000 based on AI or to immediately respond to direct voice commands.

On the other hand, the external microphone 552 may, for example, be used to analyze various sounds generated outside the autonomous vehicle 1000 using deep learning or other analysis tools to appropriately respond for safe driving.

The reference numerals shown in FIG. 2 may represent components that perform the same or similar functions as those shown in FIG. 1. FIG. 2 more specifically illustrates the relative positional relationships of the components described in FIG. 1 (based on the interior of the autonomous vehicle 1000).

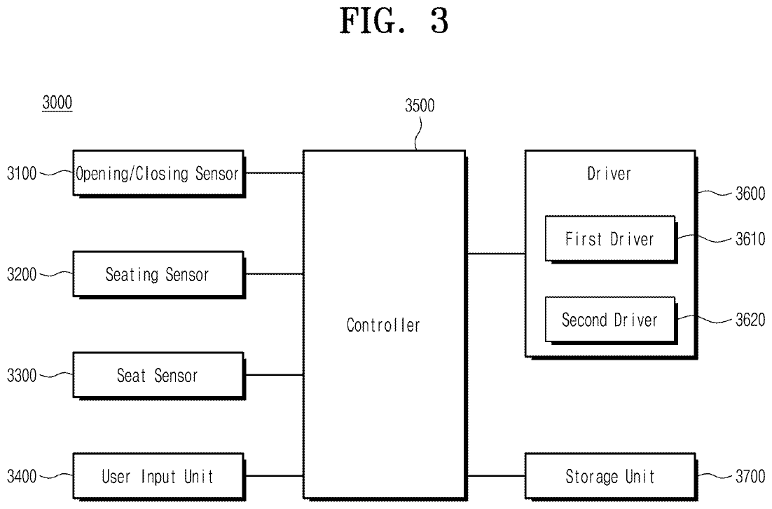

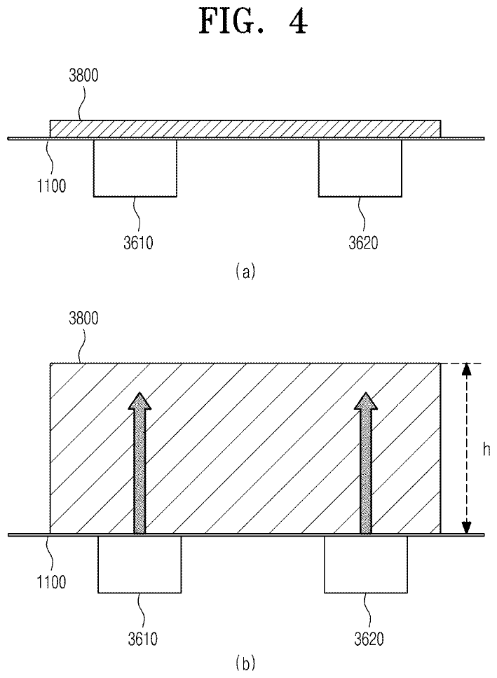

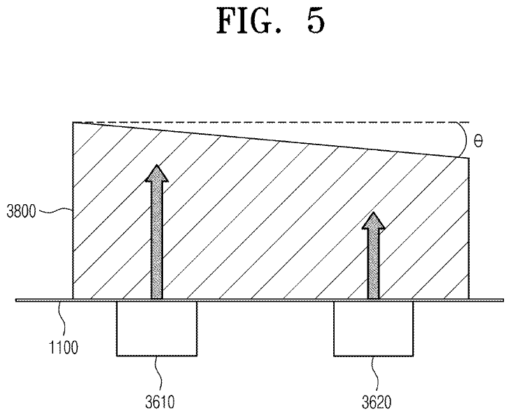

FIG. 3 is a block diagram of a vehicle control system 3000 according to embodiments of the present disclosure. FIG. 4 is a diagram illustrating how the vehicle control system 3000 provides a height adjustment function of a rear seat footrest 3800 according to embodiments. FIG. 5 is a diagram illustrating the height adjustment function provided by the vehicle control system 3000 by adjusting an angle of the rear seat footrest 3800 according to embodiments.

According to one embodiment of the present disclosure, the vehicle control system 3000 may include an opening/closing sensor 3100, a seating sensor 3200, a seat sensor 3300, a user input unit 3400, a controller 3500, and a driver 3600. Here, the opening/closing sensor 3100, the seating sensor 3200, and the seat sensor 3300 may correspond to various sensors described above with reference to FIG. 1, and the controller 3500 may correspond to the integrated controller 600 shown in FIG. 1. Also, the user input unit 3400 may correspond to the user input unit 100 shown in FIG. 1.

Referring to FIGS. 3 to 5, in the vehicle control system 3000 according to one embodiment of the present disclosure, the opening/closing sensor 3100 may sense or detect whether the rear seat door is opened or closed. The seating sensor 3200 may sense or detect whether a user is seated in the rear seat. The seat sensor 3300 may sense or detect the position and angle of the front seat located in front of the rear seat.

Here, the front seat may be the driver's seat or the front occupant's seat as mentioned above. A guide rail may be provided under the front seat, allowing the user to slide the front seat forward and backward, and the recline angle of the backrest of the front seat may also be adjusted through operation. Therefore, in the vehicle control system 3000 of the present embodiment, the seat sensor 3300 may sense both the longitudinal position and the backrest angle of the front seat.

The user input unit 3400 may serve to receive input from the occupant. The input unit may include a console or display located in the armrest between the rear seats.

The controller 3500 may be connected to the opening/closing sensor 3100, seating sensor 3200, seat sensor 3300, and user input unit 3400, and may generate and transmit/receive control signals. Based on the control signals, the driver 3600 may drive the rear seat footrest 3800 to provide the height adjustment function.

Specifically, the controller 3500 may output, through the user input unit 3400, information for driving the rear seat footrest 3800 when the rear seat door is opened or closed and an occupant is seated in a rear seat. It may generate a control signal based on the input information received from the occupant.

For example, in the vehicle control system 3000 according to one embodiment of the present disclosure, the information output through the user input unit 3400 may include information about the occupants and control information for raising or lowering the rear seat footrest 3800.

Furthermore, in the case where interference with the front seat is sensed while the rear seat footrest 3800 is being operated, the controller 3500 may output, through the input unit 3400, information indicating that operation of the rear seat footrest 3800 is not possible.

Additionally, when interference with the front seat is sensed to occur during operation of the rear seat footrest 3800, the controller 3500 may generate a control signal to adjust the angle of the rear seat footrest 3800. The driver 3600 then provides the height adjustment function by adjusting the angle of the rear seat footrest 3800.

Further, when the rear seat door is opened or closed and the rear seat is not sensed to be occupied, the controller 3500 may generate a control signal to return the rear seat footrest 3800 to the original position of the rear seat footrest 3800. In the case where the engine of the vehicle is turned off or the doors of the vehicle are in a locked state, the driver 3600 may operate to return the rear seat footrest 3800 to the original position thereof based on the control signal to provide the height adjustment function.

The driver 3600 may include a first driver 3610 disposed at a front lower portion of the rear seat footrest 3800, and a second driver 3620 disposed at a rear lower portion of the rear seat footrest. In addition, the vehicle control system 3000 according to one embodiment of the present disclosure may include a storage unit 3700 configured to store input information received from the occupant. In some embodiments, the storage unit 3700 may be referred to as a storage.

FIG. 4-(a) shows the rear seat footrest 3800 disposed on a lower frame 1100 of the vehicle.

FIG. 4-(b) shows that the rear seat footrest 3800 is elevated by height “h” from the lower frame 1100 using the first driver 3610 and second driver 3620 to provide the height adjustment function.

Furthermore, in the vehicle control system 3000, the first driver 3610 and the second driver 3620 may be operated independently to tilt the rear seat footrest 3800 by an angle θ to provide the height adjustment function, as shown in FIG. 5. The first driver 3610 and the second driver 3620 may also be operated independently to tilt the rear seat footrest 3800 differently.

Thereby, the height adjustment function of the rear seat footrest 3800 may be provided for the comfort of the occupant sitting on the rear seat of the vehicle 1000. In addition, input information received from the occupant may be stored to automatically provide the height adjustment function of the rear seat footrest 3800. Furthermore, the height adjustment function of the rear seat footrest 3800 may be provided without any interference with the front seat. Further details on this function are described below.

Note that the block diagram of the vehicle control system 3000 in FIG. 3 illustrates merely one embodiment of the present disclosure. Each component of the block diagram may be integrated, added, or omitted depending on the specifications of the vehicle control system 3000 that is actually implemented.

In other words, two or more components may be combined into one component, or one component may be subdivided into two or more components. Also, it should be noted that the functions performed by the respective blocks are merely examples used to describe embodiments of the present disclosure and that the specific operations or devices thereof do not limit the scope of the present disclosure.

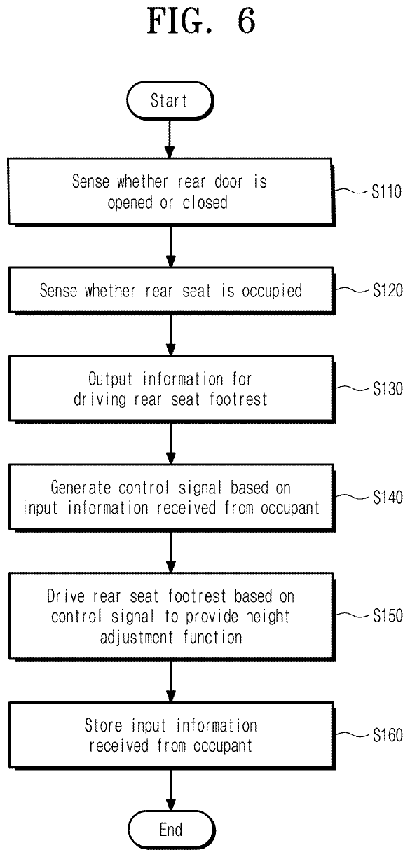

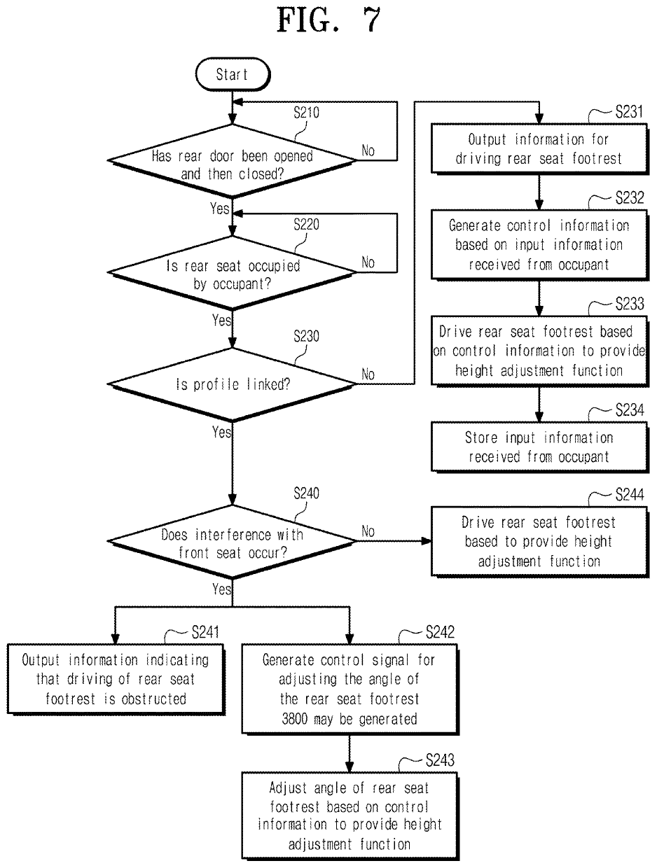

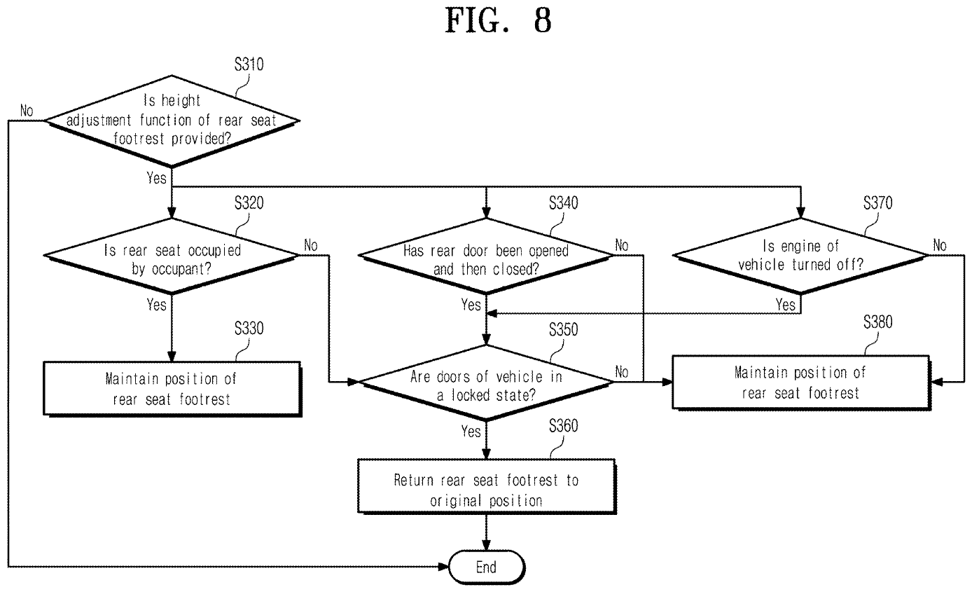

FIG. 6 is a diagram illustrating a vehicle control method according to embodiments. FIG. 7 is a diagram illustrating a case where interference occurs with a front seat in the vehicle control method according to embodiments. FIG. 8 is a diagram illustrating a case where a rear seat footrest returns to the original position thereof in the vehicle control method according to embodiments.

Hereinafter, a vehicle control method according to embodiments of the present disclosure is described with reference to FIGS. 3 to 5.

Referring to FIG. 6, in the vehicle control method according to one embodiment of the present disclosure, it may be first sensed whether a rear door is opened or closed through the opening/closing sensor 3100 (S110). Then, it may be sensed whether a rear seat is occupied through the seating sensor 3200 (S120). Then, information for driving the rear seat footrest is output through the user input unit 3400 (S130), and a control signal may be generated by the controller 3500 based on the input information received from an occupant (S140). The driver 3600 may then drive the rear seat footrest 3800 based on the control signal to provide the height adjustment function (S150). Additionally, the input information received from the occupant may be stored in the storage unit 3700 (S160).

More specifically, referring to FIG. 7, in the vehicle control method according to one embodiment, it may be sensed whether a rear door has been opened and then closed (S210), and it may be sensed whether a rear seat is occupied by an occupant (S220). Then, input information stored in the storage unit 3700 may be output through the user input unit 3400.

The occupant may link his/her profile by selecting the pre-stored information from the output information. That is, with the vehicle control method according to one embodiment of the present disclosure, when a previously boarded occupant boards again, the rear seat footrest 3800 may be conveniently driven to provide the height adjustment function without any separate settings by using the pre-stored information.

In addition, in the vehicle control method according to one embodiment of the present disclosure, it may be determined whether the profile is linked (S230). In the case where the profile linkage has not been performed, information for driving the rear seat footrest 3800 may be output, as described above with reference to FIG. 6 (S231), and a control signal may be generated based on input information received from the occupant (S232). Then, the rear seat footrest 3800 may be driven based on the control signal to provide the height adjustment function (S233), and the input information received from the occupant may be stored (S234). Thereby, the above-described profile linkage may be performed for each occupant.

Furthermore, in the vehicle control method according to one embodiment of the present disclosure, it may be determined whether the profile linkage has been performed (S230), and when the profile linkage has been performed, it may be determined whether interference with the front seat occurs (S240).

This is because the front seats located on the driver's side and occupant's side can move back and forth and adjust the angle of the backrests thereof are adjustable, which may be restrictions during the driving of the rear seat footrest 3800.

When no interference occurs between the rear seat footrest 3800 and the front seat, the rear seat footrest 3800 may be driven to provide the height adjustment function (S244). On the other hand, when interference occurs between the rear seat footrest 3800 and the front seat, information indicating that driving of the rear seat footrest 3800 is obstructed may be output through the user input unit 3400 (S241). Based on the output information, the occupant may move the front seat or adjust the backrest angle thereof to allow the rear seat footrest 3800 to be driven to provide the height adjustment function.

Additionally, when interference occurs between the rear seat footrest 3800 and the front seat, a control signal for adjusting the angle of the rear seat footrest 3800 may be generated (S242), and the rear seat footrest 3800 may be adjusted based on the generated control signal to provide the height adjustment function. That is, as described above with reference to FIG. 5, the interference with the front seat may be avoided by adjusting the angle θ of the rear seat footrest 3800 using the first driver 3610 and the second driver 3620, which are driven individually.

Referring also to FIG. 8, in the vehicle control method according to one embodiment of the present disclosure, when the height adjustment function of the rear seat footrest 3800 is provided (S310), it may be determined whether the rear seat is occupied by an occupant (S320), and the position of the rear seat footrest 3800 may be maintained (S330).

In addition, in the vehicle control method according to one embodiment of the present disclosure, when the height adjustment function of the rear seat footrest 3800 is provided (S310), it may be determined whether a rear door has been opened and closed (S340). In the case where the rear door has been opened but not closed, which may mean that the occupant is still seated in the rear seat, the position of the rear seat footrest 3800 may be maintained (S380).

In the case where the rear door has been opened and then closed, it may be determined whether the doors of the vehicle are in a locked state (S350). In the case where the doors of the vehicle are locked after the rear door has been opened and closed, the rear seat footrest 3800 may be returned to the original position thereof by driving the rear seat footrest 3800 using the driver 3600 (S360).

On the other hand, in the case where the doors of the vehicle are not locked after the rear door has been opened and closed, the position of the rear seat footrest 3800 may be maintained in consideration of, for example, the case where the occupant is re-seated within a short period of time (S380).

Also, in the case where no occupant is seated in the rear seat, it may be determined whether the doors of the vehicle are in a locked state (S350). Then, as described above, the rear seat footrest 3800 may be returned to the original position thereof (S360) or the position of the rear seat footrest 3800 may be maintained (S380).

Furthermore, in the vehicle control method according to one embodiment of the present disclosure, when the height adjustment function of the rear seat footrest 3800 is provided (S310), it may be determined whether the engine of the vehicle is turned off (S370).

In the case where the engine is not turned off, the position of the rear seat footrest 3800 may be maintained because the occupant may be still seated in the rear seat (S380). In the case where the engine is turned off, it may be determined whether the doors of the vehicle are in a locked state (S350). As described above, when the doors of the vehicle are not locked, the position of the rear seat footrest 3800 may be maintained (S380). When the doors of the vehicle are locked, the rear seat footrest 3800 may be returned to the original position thereof (S360).

In summary, the vehicle control system and method according to the present disclosure may provide the height adjustment function of the rear seat footrest for the comfort of an occupant seated in the rear seat. In addition, the input information received from the occupant may be stored such that the height adjustment function of the rear seat footrest may be automatically provided. Also, the height adjustment function of the rear seat footrest may be provided without causing interference with the front seat.

The foregoing detailed description is to be construed in all aspects as illustrative and not restrictive. The scope of the present disclosure should be determined by the reasonable interpretation of the appended claims. Thus, it is intended that the present disclosure cover the modifications and variations of this disclosure provided they come within the scope of the appended claims and their equivalents.

What is claimed is:

1. A vehicle control system for providing a height adjustment function of a rear seat footrest, comprising:
an opening/closing sensor configured to sense whether a rear door is opened or closed;
a seating sensor configured to sense whether a rear seat is occupied;
a seat sensor configured to sense a position and angle of a front seat located in front of the rear seat;
a user input assembly configured to receive an input from an occupant;
a controller connected to the opening/closing sensor, the seating sensor, the seat sensor, and the user input assembly, the controller being configured to generate and transmit a control signal; and
a driver configured to drive the rear seat footrest based on the control signal to provide the height adjustment function.

2. The vehicle control system of claim 1, wherein, based on that the rear door is opened or closed and the occupant is seated on the rear seat, the controller outputs information for driving the rear seat footrest through the user input unit, and generates the control signal based on input information received from the occupant.

3. The vehicle control system of claim 2, wherein, based on interference with the front seat occurring during the driving of the rear seat footrest, the controller outputs, through the user input unit, information indicating that the driving of the rear seat footrest is obstructed.

4. The vehicle control system of claim 2, wherein, based on interference with the front seat occurring during the driving of the rear seat footrest, the controller generates a control signal for adjusting an angle of the rear seat footrest,
wherein the driver adjusts the angle of the rear seat footrest based on the control signal to provide the height adjustment function.

5. The vehicle control system of claim 2, further comprising:
a storage configured to store the input information received from the occupant.

6. The vehicle control system of claim 1, wherein, based on that the rear door is opened or closed and the rear seat is not occupied, the controller generates a control signal to return the rear seat footrest to an original position of the rear seat footrest.

7. The vehicle control system of claim 6, wherein, based on that an engine of the vehicle is turned off or that doors of the vehicle are in a locked state, the driver returns the rear seat footrest to the original position to provide the height adjustment function.

8. The vehicle control system of claim 1, wherein the driver comprises:
a first driver disposed at a front lower portion of the rear seat footrest; and
a second driver disposed at a rear lower portion of the rear seat footrest.

9. A vehicle control method for providing a height adjustment function of a rear seat footrest, the method comprising:
sensing whether a rear door is opened or closed through an opening/closing sensor;
sensing whether a rear seat is occupied through a seating sensor;
outputting information for driving the rear seat footrest through a user input assembly;
generating a control signal based on input information received from an occupant; and
driving the rear seat footrest through a driver based on the control signal to provide the height adjustment function.

10. The vehicle control method of claim 9, further comprising:
sensing a position and angle of a front seat located in front of the rear seat through a seat sensor; and
based on interference with the sensed front seat occurring during the driving of the rear seat footrest, outputting, through the user input unit, information indicating that the driving of the rear seat footrest is obstructed.
